(19) United States
(12) Patent Application Publication
(10) Pub. No.: US 2006/0120806 A1
(43) Pub. Date: Jun. 8, 2006

(54) Storing biogas in wells

(75) Inventors: Jerry Leone, Victor, NY (US); Larry Shilling, Alfred Station, NY (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Casella Waste Systems, Inc., Rutland, VT (US)

(21) Appl. No.: 11/006,580

(22) Filed: Dec. 8, 2004

(51) Int. Cl. B09C 1/00

(52) U.S. Cl. 405/129.85

(57) ABSTRACT

The invention provides wells comprising biogas; methods for storing biogas in wells; methods for producing energy from biogas; methods for stimulating natural gas production from natural gas wells using biogas; and methods for removing carbon dioxide and other impurities from biogas.

### FIELD OF THE INVENTION

The invention relates to the use and storage of biogas in wells.

### BACKGROUND OF THE INVENTION

Biological decomposition of wastes placed in a landfill site produces biogas. Biogas represents both an environmental liability and a unique renewable energy resource. Biogas, composed primarily of methane and carbon dioxide, also commonly contains additional trace constituents such as hydrogen sulfide, mercaptans, vinyl chloride, and other volatile organic compounds. Concerns that are often associated with biogas relate to odors, air quality impacts and explosion hazards. If released to the atmosphere untreated, biogas is also a potent greenhouse gas contributing to global climate change. The methane component of biogas contains energy that could be used to generate electricity, heat buildings, fuel industrial processes, or run vehicles. Utilization of energy from biogas not only aids in the control of local environmental impacts, but also avoids consumption of fossil fuels that would otherwise be required to generate an equal amount of energy. Collection and use of biogas represents a significant opportunity to reduce greenhouse gas emissions to the atmosphere.

Due to the presence of carbon dioxide, nonmethane organics, and other contaminants, biogas cannot economically be stored in tanks for future use. Since biogas is constantly being produced over a significant period of time, including off-peak periods when energy costs are lower, the aspect of using biogas for peak shaving would provide significant economic benefits. Peak shaving refers to the time periods when power companies charge higher cost because of an increased demand on the utility. Typically a utility has two rates it charges for consumption, Peak and Off-Peak. The utility monitors the draw on their system and can tell when the Peak and Off-Peak occur. When an energy engineer looks into peak shaving, they are focusing on the Peak time period and how the consumption during that time period can be reduced or “shaved”. The invention is directed to these, as well as other, important ends.

### SUMMARY OF THE INVENTION

The invention provides wells comprising biogas and an apparatus to maintain the biogas in the well; wherein the biogas comprises more than 40% methane and less than 75% carbon dioxide. In one embodiment, the biogas is under pressure in the well. The well generally comprises one or more casings selected from the group consisting of a conductor casing, a surface casing, an intermediate casing, a liner string, and a production casing. The well also generally comprises one or more completions selected from the group consisting of an open hole completion, a perforated completion, a sand exclusion completion, a permanent completion, a multiple zone completion, and a drainhole completion. In other embodiments, the biogas comprises about 40% to about 90% methane; about 10% to about 60% carbon dioxide; 0% to about 10% nitrogen; 0 to about 3% hydrogen; and 0 to about 2% oxygen. In one embodiment, the biogas is landfill gas.

The invention provides methods for storing biogas by injecting biogas into a well, and pressurizing the well to store the biogas. The biogas may comprise at least 40% methane; or the biogas may comprise about 40% to about 90% methane; about 10% to about 60% carbon dioxide; 0% to about 10% nitrogen; 0 to 3% hydrogen; and 0 to 2% oxygen. In other embodiments, the invention provides methods for storing biogas by removing biogas from a source (e.g., landfill, bioreactor); transporting the biogas to a well; injecting the biogas into the well; and pressurizing the well to store the biogas. The methods may comprise cleaning the biogas to remove impurities before the biogas is injected into the well and/or after the biogas is removed from the well.

The invention provides methods for producing energy from biogas by removing biogas from a source (e.g., a landfill, a bioreactor); transporting the biogas to a well; injecting the biogas into the well; pressurizing the well to store the biogas; withdrawing the biogas from the well; and using the biogas to produce energy. In one embodiment, the energy is used for peak shaving.

The invention provides methods for stimulating natural gas production in a natural gas well by injecting biogas into the well; applying pressure to the biogas in the well; and removing the biogas from the well; wherein the biogas that is removed from the well contains a greater concentration of methane than the biogas that is injected into the well. In one embodiment, the natural gas well is an inactive natural gas well that is not a commercially viable source of natural gas. In order to further stimulate natural gas production, the methods may comprise hydraulically fracturing the well. The biogas that is injected into the well comprises at least 40% methane and less than 60% carbon dioxide.

The invention provides methods for removing carbon dioxide from biogas by injecting biogas into a well; pressurizing the well; maintaining the pressurized well for a period of time sufficient to allow sequestration of the carbon dioxide from the biogas into the earth; and removing the biogas from the well; wherein the biogas that is removed from the well contains less carbon dioxide than the biogas that was injected into the well. The methods for stimulating natural gas production and removing carbon dioxide from biogas may occur simultaneously when the well is a natural gas well, such as a commercially defunct natural gas well.

These and other aspects of the invention are described in more detail herein.

### FIGURE

FIG. 1 shows one embodiment of a deep-well that may be used in the invention.

### DETAILED DESCRIPTION OF THE INVENTION

The invention provides a biogas storage system using deep wells. Biogases are injected into wells using blowers or compressors to pressurize the biogas to a sufficient pressure for storage of the biogas in the well, generally within the fractures beyond the well.

Biogas, a renewable fuel, is generated when bacteria degrade biological material in the absence of oxygen in a process known as anaerobic digestion. Biogas generally comprises about 25% to about 95% methane. In another embodiment, biogas comprises about 30% to about 90% methane and less than about 75% carbon dioxide, less than about 65% carbon dioxide, or less than about 50% carbon dioxide. In another embodiment, biogas comprises about 40% to about 90% methane; about 10% to about 60% carbon dioxide; 0% to about 10% nitrogen; 0 to 3% hydrogen; and 0 to 2% oxygen. One skilled in the art will appreciate that biogas may contain other impurities such as solids and liquids. The liquids are generally in the form of condensate when the biogas cools.

Biogas may originate from any source of biological material known in the art. Exemplary sources of biological material that can generate biogas include marshes, landfills, septic tanks, farms (e.g., cattle and/or dairy farms), sewage treatment facilities, paper mills, olive oil mills, industrial food production facilities (e.g., potato processing; canning; production of juices, frozen food or salads; slaughter houses), and the like. When the source of the biogas is a landfill, the biogas may be referred to as landfill gas. A bioreactor can optionally be used to generate biogas on farms, at sewage treatment plants, at olive oil mills, at industrial food production facilities, and at paper mills. Methods for collecting and generating biogas from bioreactors and landfills are known in the art.

Bioreactors may be made out of concrete, steel, brick, or plastic; may be shaped like silos, troughs, basins or ponds, and may be placed underground or on the surface. All designs incorporate the same basic components: a pre-mixing area or tank, a digester vessel(s), a system for using the biogas, and a system for distributing or spreading the effluent (the remaining digested material). There are two basic types of bioreactors: batch and continuous. Batch-type bioreactors are the simplest to build. Their operation consists of loading the digester with organic materials and allowing it to digest. The retention time depends on temperature and other factors. Once the digestion is complete, the effluent is removed and the process is repeated. In a continuous bioreactor, organic material is constantly or regularly fed into the digester. The material moves through the bioreactor either mechanically or by the force of the new feed pushing out digested material. Unlike batch-type bioreactors, continuous bioreactors produce biogas without the interruption of loading material and unloading effluent. They may be better suited for large-scale operations. There are at least three types of continuous bioreactors: vertical tank systems, horizontal tank or plug-flow systems, and multiple tank systems. Proper design, operation, and maintenance of continuous bioreactors produce a steady and predictable supply of usable biogas. Many livestock operations store the manure they produce in waste lagoons, or ponds. A growing number of these operations are placing floating covers on their lagoons to capture the biogas.

Exemplary methods for collecting biogas from landfills are described in U.S. Pat. Nos. 4,026,355, 4,442,901, 4,469,176, 4,518,399, 4,670,148, and 5,206,067 the disclosures of which are incorporated by reference in their entirety. The biogas may-be collected from one or more deep and/or shallow wells drilled into the landfill. The wells can be vertical and/or horizontal. The common technique for recovering biogas from a landfill is to drill vertical and/or horizontal wells, the depth of which may be, for example, from about 30 feet to about 250 feet. The wells may be lined with perforated casings so that biogas can enter the wells through the perforations. To induce biogas to flow into the well, the well may be maintained at or below local atmospheric pressure. The chemical reaction within the landfill creates a pressure greater than atmospheric so that the biogas migrates into the well. To augment this natural flow, a pump may be used to reduce the pressure in the well below ambient.

The bioreactor or landfill wells are connected to one or more blowers via a conduit or pipe line. The pipe line may be a low pressure gas-gathering pipe line. The blower may increase the gas pressure from less than atmospheric level (vacuum). In one embodiment of the invention, blower increases the gas pressure to about 20 psig or more; about 40 psig or more; or about 60 psig or more.

The biogas is transported from its source by a conduit to an underground storage system. In one embodiment, the underground storage system is a deep well. The deep well storage system is employed to provide a safe and economic means for storage that is not exposed to damage by vandalism or accidents. The deep well may extend from the surface of the earth to below the base of the deepest potable water aquifer, and may be cased along its full length. The deep well may be about 500 feet deep or more; about 1,000 feet deep or more; about 1,500 feet deep or more; about 2,000 feet deep or more; about 2,500 feet deep or more; or about 3,000 feet deep or more. The deep well may be on land or under water. A deep well on land may be a man-made well or a natural well. The well may be drilled specifically for the purpose of storing biogas or may be a natural gas well, public supply well, oil well, coal-bed well, or the like. In one embodiment, the well is an inactive natural gas well. The term “inactive” means that the well does not produce enough natural gas to make it economically viable to operate. An under water well may be, for example, under a lake bed or under the ocean floor.

The deep well may be constructed with one or more casings. Well casing comprise a series of metal or plastic tubes installed in a drilled hole. Casing serves to strengthen the sides of the well hole, ensure that no gas seeps out of the well hole, and to keep other fluids or gases from seeping into specific formations through the well. Types of casing used depend on the subsurface characteristics of the well, including the diameter of the well and the pressures and temperatures experienced throughout the well. In most wells, the diameter of the well hole decreases the deeper it is drilled, leading to a type of conical shape that must be taken into account when installing casing. The interior of the casing may optionally comprise a complete or partial polymer coating, such as a high density polyethylene coating. A polymer coating within the casing would prevent any reactions between the biogas and the coating. For example, at least a partial polymer coating would prevent hydrogen sulfide in the biogas from reacting with a metal casing.

There are generally five different types of well casing that may be used in the invention, either individually or in combinations of two or more thereof. The casings include conductor casing, surface casing, intermediate casing, liner string, and production casing.

Conductor casing may be installed first. The hole for conductor casing may be drilled with a small auger drill. Conductor casing, which may be from about 20 to about 50 feet long, may be installed to prevent the top of the well from caving in and to help in the process of circulating the drilling fluid up from the bottom of the well. On land, this casing may be about 16 to about 20 inches in diameter while offshore casing usually measures about 30 to about 42 inches in diameter. The conductor casing may be cemented into place before drilling begins.

Surface casing is the next type of casing that may be installed. It can be anywhere from about a few hundred to about 2,000 feet long, and is usually smaller in diameter than the conductor casing. When installed, the surface casing fits inside the top of the conductor casing. The primary purpose of surface casing is to protect fresh water deposits near the surface of the well from being contaminated. It also serves as a conduit for drilling mud returning to the surface, and helps protect the drill hole from being damaged during drilling. Surface casing, like conductor casing, may also be cemented into place. Regulations often dictate the thickness of the cement to be used, to ensure that there is little possibility of freshwater contamination.

Intermediate casing is usually the longest section of casing found in a well. The primary purpose of intermediate casing is to minimize the hazards that come along with subsurface formations that may affect the well. These include abnormal underground pressure zones, underground shales, and formations that might otherwise contaminate the well. In many instances, even though there may be no evidence of an unusual underground formation, intermediate casing is run as insurance against the possibility of such a formation affecting the well. These intermediate casing areas may also be cemented into place for added protection.

Liner strings are sometimes used instead of or in addition to intermediate casing. Liner strings are commonly run from the bottom of another type of casing to the open well area. However, liner strings are usually attached to the previous casing with ‘hangers,’ instead of being cemented into place. This type of casing is thus less permanent than intermediate casing.

Production casing, is installed last and is the deepest section of casing in a well. This is the casing that provides a conduit from the surface of the well to the storage formation in the earth. The size of the production casing depends on a number of considerations, including the lifting equipment to be used, the number of completions required, and the possibility of deepening the well at a later time.

Well casing is a very important part of the completed well. In addition to strengthening the well hole, it also provides a conduit to allow biogases to be stored and to be extracted without intermingling with other fluids and formations found underground.

The deep well may undergo a process of finishing called completion so that it is ready to store biogas. Completion may comprise deciding on the characteristics of the portion of the well in the targeted formation. There are a number of types of completions known in the art. Exemplary completions include open hole completions, conventional perforated completions, sand exclusion completions, permanent completions, multiple zone completions, and drainhole completions. The use of any type of completion depends on the characteristics and location of the formation for storage of the biogas.

In one embodiment, the deep well is finished using open hole completions. Open hole completions are the most basic type and are only used in very competent formations, which are unlikely to cave in. An open hole completion comprises running the casing directly down into the formation, and leaving the end of the piping open without any other protective filter.

In another embodiment, the deep well is finished using perforated completions, which comprise a production casing being run through the formation. The sides of this casing may be perforated, with holes along the sides facing the formation, which allows for the flow of biogas into and out of the well hole, but still provides a suitable amount of support and protection for the well hole.

In another embodiment, the deep well is finished using sand exclusion completions. Sand exclusion completions are designed for production in an area that contains a large amount of loose sand. These completions may be designed to allow for the flow of biogas into and out of the well, but at the same time prevent sand from entering the well. Sand inside the well hole may cause complications, including erosion of casing and other equipment. The most common method of keeping sand out of the well hole are screening or filtering systems. This includes analyzing the sand experienced in the formation and installing a screen or filter to keep sand particles out. This filter may either be a type of screen hung inside the casing, or adding a layer of specially sized gravel outside the casing to filter out the sand.

In another embodiment, the deep well is finished using permanent completions. Permanent completions are those in which the completion, and wellhead, are assembled and installed only once. Installing the casing, cementing, perforating, and other completion work is done with small diameter tools to ensure the permanent nature of the completion. Completing a well in this manner can lead to significant cost savings compared to other types.

In another embodiment, the deep well is finished using multiple zone completions. Multiple zone completion is the practice of completing a well such that biogas may be stored in two or more formations simultaneously. For example, a well may be drilled that passes through a number of formations on its way deeper underground, or alternately, it may be efficient in a horizontal well to add multiple completions to store biogas in the formation most effectively. Although it is common to separate multiple completions so that the different formations do not intermingle, the complexity of achieving complete separation is often a barrier. When it is necessary to separate different completions, hard rubber packing instruments are used to maintain separation.

In another embodiment, the deep well is finished using drainhole completions. Drainhole completions are a form of horizontal or slant drilling. This type of completion consists of drilling out horizontally into the formation from a vertical well, essentially providing a ‘drain’ for the biogas to run down into the well.

The deep well includes one or more wellheads, which are apparatus mounted at the opening of the well to regulate and monitor the input, storage and extraction of biogas within the well and underground formation. The wellheads may also serve as a place to monitor the contents of the biogas within the well. The wellhead may be flush with the ground or may protrude from the ground. The wellheads should be of sufficient strength to store the biogas at any pressure, including pressures of about 25 psi or more; about 100 psi or more; about 500 psi or more; or about 1,000 psi or more. Biogas may be stored within the earth for about 1 day or longer; about 1 week or longer; or about 1 month or longer prior to use. The biogas may be removed from the well at any time in order to generate energy. Methods for generating energy from biogas are known in the art.

The volume and storage capacity of a well can be increased by hydraulic fracturing. Hydraulic fracturing is used to create cracks in subsurface geologic formations. The cracks may extend 250 feet or more from the drill hole. One technique to accomplish hydraulic fracturing is to pump high volumes of water into the drill hole at high pressure, e.g., up to 3,000 psi. In other embodiments, hydraulic fracturing can be accomplished with dynamite, dry ice or compressed air. Hydraulic fracturing is particularly beneficial when the well is a natural gas well. In one embodiment, the concentration of methane gas in the well is increased by hydraulic fracturing using biogas at a high pressure in the well. The high pressure may be about 1,000 psi or more; about 2,000 psi or more; or about 3,000 psi or more. Hydraulic fracturing will open seams within the earth that will allow for the release of natural gas, which will increase the concentration of methane in the stored biogas.

In one embodiment, the invention provides methods for stimulating natural gas production from a natural gas well by injecting biogas into the well. The biogas is preferably injected and/or stored under pressure as described herein. Hydraulic fracturing may optionally be used to further stimulate natural gas production; however, it is not required. The pressurized biogas in the well may be sufficient by itself to stimulate the release of natural gas from formations surrounding the well. In one embodiment, the natural gas well is inactive.

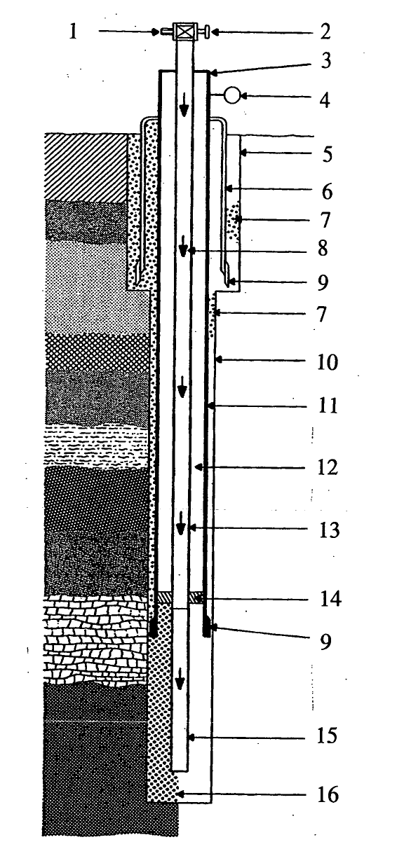

FIG. 1 shows one embodiment of a well according to the invention. The well may comprise an input 1 to inject the biogas into the well; an output 2 to remove the biogas from the well; a tubing head 3, a pressure meter 4, a surface hole 5, a surface pipe casing 6, concrete 7, injection string 8, shoe 9, bore hole 10, well casing long string 11, annulus 12, tubing 13, bottom hole packer 14, an injection screen 15, and a gravel pack 16. The injection screen 15 serves as the completion in this embodiment of the invention, and may be any of the completions described herein.

Prior to injecting biogas into the well and/or after being stored and removed from the well, the biogas may be cleaned to remove components other than methane. Cleaning can include removing carbon dioxide, liquids (e.g., condensates), solid particulate matter and other impurities (e.g., hydrogen sulfide) from the biogas to produce relatively pure methane gas. “Relatively pure” methane gas comprises at least about 80% methane; at least about 90% methane; at least about 95% methane; or at least about 99% methane. Removal of carbon dioxide from gas mixtures is known in the art and described, for example, in U.S. Pat. Nos. 3,130,026, 3,453,835 3,975,172, 4,252,548 and 5,642,630, the disclosures of which are incorporated by reference herein in their entirety. Processes for separating carbon dioxide from other gases include refrigeration to cause solid carbon dioxide deposition, a molecular sieve to capture carbon dioxide, chemical absorption or a combination of such techniques. Scrubbing a gas mixture with a solvent for carbon dioxide has been incorporated in several separation processes. Methods for removing liquids from biogas are known in the art and include, for example, lamellar pack condensation separators and cyclone-type condensation separators. Dry filters may be used to remove solid impurities.

The subsurface injection of biogas can also be used as a means to clean the biogas by removing carbon dioxide and other components from the biogas. Since carbon dioxide is heavier than methane, a portion of the entrained carbon dioxide from the biogas may remain within the earth thereby cleaning the biogas to produce a gas that contains relatively more methane. To the extent that the carbon dioxide could be sequestered in the earth by this process, additional economic advantages may be realized.

While certain embodiments and details have been shown for the purpose of illustrating the invention, it will be apparent to one skilled in the art that various changes and modifications may be made without departing from the spirit or scope of the invention.

What is claimed is:

1. A well comprising biogas and an apparatus to maintain the biogas in the well; wherein the biogas comprises more than 40% methane and less than 75% carbon dioxide.

2. The well of claim 1, wherein the well comprises one or more casings selected from the group consisting of a conductor casing, a surface casing, an intermediate casing, a liner string, and a production casing.

3. The well of claim 1, wherein the well comprises one or more completions selected from the group consisting of an open hole completion, a perforated completion, a sand exclusion completion, a permanent completion, a multiple zone completion, and a drainhole completion.

4. The well of claim 1, wherein the biogas comprises about 40% to about 90% methane; about 10% to about 60% carbon dioxide; 0% to about 10% nitrogen; 0 to about 3% hydrogen; and 0 to about 2% oxygen.

5. The well of claim 1, wherein the well is at least 3,000 feet deep.

6. The well of claim 3, wherein the biogas is in one or more fractures in the earth beyond the well.

7. The well of claim 1, wherein the biogas is landfill gas.

8. A method for storing biogas comprising injecting biogas into a well, and pressurizing the well to store the biogas.

9. The method of claim 8, wherein the biogas comprises at least 40% methane.

10. The method of claim 9, wherein the biogas comprises about 40% to about 90% methane; about 10% to about 60% carbon dioxide; 0% to about 10% nitrogen; 0 to 3% hydrogen; and 0 to 2% oxygen.

11. A method for storing biogas comprising:
(i) removing biogas from a landfill;
(ii) transporting the biogas to a well;
(iii) injecting the biogas into the well; and
(iv) pressurizing the well to store the biogas.

12. The method of claim 11, wherein the well is at least 2,000 feet deep.

13. The method of claim 11, further comprising cleaning the biogas to remove impurities.

14. A method for producing energy from biogas comprising:
(i) removing biogas from a source;
(ii) transporting the biogas to a well;
(iii) injecting the biogas into the well;
(iv) pressurizing the well to store the biogas;
(v) withdrawing the biogas from the well; and
(vi) using the biogas to produce energy.

15. The method of claim 14, wherein the source is a landfill.

16. The method of claim 14, wherein the source is a bioreactor.

17. A method for stimulating natural gas production from a natural gas well comprising:
(i) injecting biogas into the well;
(ii) applying pressure to the biogas in the well;
(iii) removing the biogas from the well; wherein the biogas that is removed from the well contains a greater concentration of methane than the biogas that is injected into the well.

18. The method of claim 17, wherein the natural gas well is an inactive natural gas well.

19. The method of claim 17, further comprising hydraulically fracturing the well.

20. The method of claim 17, wherein the biogas that is injected into the well comprises at least 40% methane and less than 60% carbon dioxide.
